(19) United States
(12) Patent Application Publication
(10) Pub. No.: US 2004/0085446 A1
(43) Pub. Date: May 6, 2004

(54) Method for secured video signal transmission for video surveillance system

(76) Inventor: Ho-sang Park, Pyungtaek-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/286,984

(22) Filed: Oct. 30, 2002

(51) Int. Cl. H04N 7/18; H04N 9/47

(52) U.S. Cl. 348/143

(57) ABSTRACT

Disclosed is a video security system and a method for operating the system. The video security system includes a video camera including circuits for use encrypting data or inserting a security signal, thereby generating a secured video signal for transmission. The system further includes a receiving unit, which is configured to receive the transmitted secured video signal. The receiving unit includes circuits to decrypt any encrypted signals and/or to manipulate security signal to confirm that there is no hacking or interception during the transmission. The method for operation of the security system includes providing a usable video signal and processing the usable video signal to provide a secured video signal. The usable video signal is a video image signal for use in a display with substantially little or no signal processing. The secured video signal includes at least one of an encrypted signal and a security signal. The method further includes processing secured video signal for displaying the video image conveyed in the secured video signal.

### RELATED US APPLICATIONS

This application is related to U.S. patent application Ser. No. ______ (not assigned), filed concurrently herewith and entitled “Apparatus for Secured Video Signal Transmission for Video Surveillance System,” which is hereby incorporated by reference herein.

### BACKGROUND OF THE INVENTION

1. Field of the Invention

The present invention relates to a video security or surveillance system. More particularly, the present invention relates to improving security of video signal transmission so as to prevent duplication, alteration and hacking of video signals.

2. Description of the Related Technology

A typical video security or surveillance system has one or more video camera near or at the site(s) of surveillance and a control machine. Typically, the one or more cameras are constantly connected to the control machine via a wired line and transfer video signals to the control machine, which process the signal to monitor the video images and/or store the video image data. The control machine includes a video data storage device and a display for monitoring the video images. Recent, various aspects of digital technology have been incorporated in video security systems and have provided improved image quality and storage capacity, and additional function such as image search.

FIG. 10 is a block diagram showing a configuration of a conventional security system having a camera. The security system comprises a camera 10, a coaxial cable 20 for transmitting video signals generated in the camera 10 as analog signals, and a digital video recorder (DVR) 30 for storing the transmitted analog signals as digital data. In addition, the security system further comprises a monitor 50 allowing a watcher to monitor the generated video signals. A plurality of the cameras 10 may be installed in a security area and video signals simultaneously generated in the plurality of the cameras 10 may be simultaneously stored in the DVR 30.

Each camera 10 comprises a charge coupled device (CCD) 11 for outputting images, which have been captured through a lens at specific moments, as video signals, an analog to digital (A/D) converter 12 for converting the video signals into raw digital video signals, a digital signal processor (DSP) 13 for encoding the raw digital video signals into a video format according to the recommendations of International Radio Consultative Committee (CCIR) or Society of Motion Picture and Television Engineers (SMPTE), i.e. usable digital video signals, and a digital to analog (D/A) converter 14 for converting the usable digital video signals generated in the DSP 13 to composite video signals. The composite video signals, which are analog video signals, are transmitted through the coaxial cable 20, which typically has a characteristic resistance of 75 Ω and a bandwidth characteristic of about 500 Mbps for the purpose of smoothly transmitting the composite video signals.

The DVR 30 comprises an A/D converter 31 for converting the composite video signals transmitted through the coaxial cable 20 to digital signals, a data compression unit 34 for compressing the converted digital video signals by use of a MPEG (Moving Picture Experts Group) or JPEG (Joint Photographic Experts Group) method, a storage device 35, such as a hard disk, for storing the compressed data, a microprocessor 33 for controlling the A/D converter 31 and the data compression unit 34 according to a beforehand stored control program. In addition, the DVR 30 is provided with an external terminal 36 through which the video signals are outputted to the monitor 50.

U.S. Pat. No. 5,568,192 entitled “Method and Apparatus for Processing Digital Video Camera Signals” discloses a method of converting raw digital video signals themselves in a serial format and transmitting the converted signals without converting the raw digital video signals into usable digital video signals. An apparatus employing the method disclosed in the patent comprises a digital camera 700, a computer 800, a control signal line 25, and a high speed serial bus 21 as a video signal transmission line, as shown FIG. 11. The digital camera 700 is composed of a lens 710, a CCD 720, an A/D converter 730, a bit/serial converter 740 for converting raw digital video signals as outputs of the A/D converter 730 to serial data, as shown in FIG. 12. In addition, the digital camera also includes an iris 750 for supplying shutter time and an operating voltage to the CCD 720, and a controller 760 for controlling the operation of the digital camera. The digital camera 700 converts the generated video signals to the raw digital video signals with a {Y,Cr,-Cb} format through the A/D converter 730, converts the raw digital video signals to serial digital signals through the bit/serial converter 740, and then transmits a high speed serial digital bit stream to the computer 800 via the high speed serial bus 21. At this time, the controller 760 receives serial control signals from the computer 800 via the control signal line 25 and performs the control. As shown in FIG. 13, the computer 800 includes a bit/serial interface 810 for receiving the high speed serial digital bit stream via the high speed serial bus 21, a PCI interface 820 for transmitting the high speed serial digital bit stream to a processor 830 of the computer 800 via a PCI bus 850, and the processor 830 for calculating the transmitted raw digital video signals with the {Y,Cr,-Cb} format into usable digital video signals with a YUV format. Namely, the computer 800 converts the serial digital signals with the {Y,Cb,-Cr} format transmitted through the digital camera 700 to the usable digital video signals with the YUV format and displays or stores the converted usable digital video signals.

However, the security system using the camera employing the analog signal transmission scheme as described above converts the usable digital video signals converted by the DSP 130 to the composite video signals as the analog signals to be transmitted via the coaxial cable 20, and the DVR 300 converts again received composite video signals to digital signals to be compressed and stored as digital data. Therefore, there is a problem in that loss and noise of data are generated during transmission of the analog signals, or noise such as quantization noise or interpolation noise is generated during the conversion of the analog data to the digital data and the re-conversion of the digital data to the analog data, thereby resulting in loss of video signals. Further, since the conventional security system transmitting the analog data does not provide information about whether transmitted video signals are altered or offered by an external intruder, there is another problem in that video signals altered or faked by the intruder during the transmission of the video signals cannot be discriminated, which results in deterioration of the reliability of the security system.

In addition, in a case where the invention of “Method and Apparatus for Processing Digital Video Camera Signals” disclosed in the U.S. Pat. No. 5,568,192 is applied to the security system, although the loss and noise of signals during the data transmission and the analog to digital conversion can be removed, a measure for preventing faking of transmitted digital signals or insertion of any other video signals into the transmitting cable by the external intruder has not been suggested. In addition, a high performance computer is required when a mass of digital video signals is converted into the usable digital video signals, which leads to increase of cost over the DSP. In addition, since the camera used in the system of the above patent cannot directly output video signals to a general monitor, though it reduces manufacture cost, it has poor compatibility as a camera.

U.S. Pat. No. 5,862,217 issued to Eran Steinberg, et al. and entitled “Method and apparatus for in-camera encryption” discloses a technique in which before digital image data converted by a camera from light reflected on an external object are recorded in a storage device, all the digital image data are encrypted using an encryption password selected by a user and then stored, and they can be reproduced using the encrypted password in case of reproducing and outputting the image data on and to a display device or printer.

Further, in a method of encrypting the digital image data in the camera disclosed in the Eran patent, an encryption generator in the camera is first initialized using the encryption password provided by the user. Then, the light reflected on the external object is converted into original digital image data by the camera. Subsequently, all of the original digital image data are substantially encrypted within the camera. In particular, the camera cannot output the original digital image data to a monitor or printer in a state where the data have not been decrypted using the encryption password. Further, a file of the encrypted digital image data can be transmitted in an encrypted form to an external device and then its contents can be displayed on the monitor or outputted to the printer through a decryption process using the encryption password.

However, in the aforementioned conventional security system having the camera, there is a problem in that if video signals are altered or any other video signals are inserted by an external intruder during transmission of the video signals, it is impossible to discriminate the truth of the video signals, or that if the video signals are hacked by the intruder during the transmission thereof on a transmission line, it is impossible to prevent the intruder from decrypting and viewing the contents of the video signals. Furthermore, the conventional security system using the camera employing the analog signal transmission scheme converts the usable digital video signals converted by the DSP 13 to the composite video signals as the analog signals to be transmitted via the coaxial cable 20, and the DVR 30 converts again received composite video signals to digital signals to be compressed and stored as digital data. Therefore, there is a problem in that loss and noise of data are generated during transmission of the analog signals, or noise such as quantization noise or interpolation noise is generated during the conversion of the analog data to the digital data and the re-conversion of the digital data to the analog data, thereby resulting in loss of video signals.

The technique disclosed in the Eran patent entitled “Method and Apparatus for In-Camera Encryption” is a technique in which the digital image data converted from the light reflected on the external object are encrypted in the camera before they are stored in a storage medium. Although the patent discloses the technique for encrypting the digital image data in the camera, it does not teach a technique in which in an apparatus for continuously transmitting video signals, such as a security system, the video signals are encrypted and transmitted in the form of digital signals in real time, and it is prevented to alter the transmitted digital video signals, to insert any other video signals from the outside, and to decrypt them when the video signals are hacked.

### SUMMARY OF THE INVENTION

One aspect of the present invention provides a camera for use with a video surveillance system. The camera comprises: a raw video signal generator configured to generate a raw video signal from light entering into the camera; a video processor configured to process the raw video signal to produce a usable video signal for use in a display with substantially little or no additional signal processing; a security processor configured to modify the usable video signal to produce a secured video signal. The camera further comprises a lens configured to allow the light to enter the camera. The camera further comprises an output terminal configured to be connected with an external device with or without wire. The camera further comprises a parallel-to-serial converter configured to convert the secured video signal in a parallel form to a serial form. The camera further comprises a microphone capable of receiving sound and generating an audio signal from the received sound.

In the camera, the video processor is further configured to process the audio signal to produce the usable video signal incorporating the audio signal. The raw video signal generator comprises a photo-electric converter. The raw video signal generator comprises a charge coupled device (CCD). The raw video signal generator is configured to generate the raw video signal in analog form, and wherein the video processor is configured to convert the analog raw video signal to digital form. The usable video signal is in a format selected from the group consisting of International Radio Consultative Committee (CCIR) and Society of Motion Picture and Television Engineers (SMPTE). The usable video signal comprises a plurality of line video signals, wherein each line video signal is capable of displaying a line of image on a display, and wherein each line video signal comprises a vertical synchronization signal, a horizontal synchronization signal, a blanking signal and a line image signal.

In the camera, the security processor is configured to encrypt at least part of the usable video signal, and wherein the secured video signal comprises an encrypted signal. The usable video signal comprises an image segment and a control signal segment. The control signal segment comprises a blanking signal and one or more synchronization signals, and wherein the image segment comprises a line image signal representing an image of a single line in an image frame of a display. The security processor is constructed or programmed to encrypt at least part of the image segment of the usable video signal. The security processor is configured to separate the image segment from the control signal segment and further configured to encrypt the image segment based on one or more control signals contained in the control signal segment. The security processor is further configured to combine the control signal segment and the encrypted image segment. The security processor is further configured to generate a plurality of security codes, and further configure to use the plurality of security codes for the encryption of the image segment.

The security processor comprises a segment separator and an encoder, wherein the segment separator is configured to separate at least part of the image segment and the control signal segment from the usable video signal, and wherein the encoder is configured to encrypt the at least part of the image segment. The security processor is configured such that the control signal bypasses the encoder. The encoder is configured to encrypt the at least part of the image segment separated with use of at least one security code. The security processor further comprises a security code supplier configured to supply to the encoder at least one security code for use in the encryption. The security code supplier is configured to store more than one security codes, and wherein the security processor further configured or programmed to initiate the security code supplier to supply the more than one security codes. The security code supplier is further configured to repeatedly supply the more than one security codes in an order. The security processor is configured to recognize vertical and horizontal synchronization signals from the control signal, to activate the security code supplier upon recognition of the vertical synchronization signal, and to initiate the security code supplier to continuously supply the at least one security code to the encoder upon the recognition of the horizontal synchronization signal. The security processor is configured to recognize one or more synchronization signals from the control signal and further configured to initiate encoding at the encoder upon recognition of the one or more synchronization signals.

In the above-described camera, the usable video signal comprises a plurality of line video signals, wherein each line video signal is to be used for displaying a single line of an image frame, and wherein each line video signal comprises a vertical synchronization signal, a blanking signal, a horizontal synchronization signal, and a line image signal, and wherein the security processor is constructed or programmed: to separate the line image signal and the remainders from each line video signal; to encode the line image signal to provide an encoded line image signal; and to combine the encoded line image signal and the remainders to provide the secured video signal. The security processor is further constructed or programmed to recognize the vertical and horizontal synchronization signals and to synchronize the encoding of the line image signal with the recognition of the vertical and horizontal synchronization signals.

The video processor and the security processor are constructed in an integrated circuit. The security processor is configured to add a security signal to the usable video signal, and wherein the secured video signal comprises the security signal. The security signal comprises one or more sub-signals for use in confirming perfection of transmission of the security signal upon receipt. The security signal comprises one or more sub-signals for use in identifying one or more irregularities in transmission of the security signal upon receipt, wherein the one or more irregularities are selected from the group consisting of interception, alteration, hacking, duplication and replacement of at least part of the secured video signal. The usable video signal comprises an image segment and a control signal segment, and wherein the security processor is constructed or programmed to add the security signal in the control signal segment. The control signal segment comprises blanking signal and one or more synchronization signals, and wherein the security processor is constructed or programmed to insert the security signal into the blanking signal. The security signal comprises a signal representing an identification code for the camera. The security signal comprises a signal indicative of a relative order of each image segment. The usable video signal comprises a plurality of line video signals, wherein each line video signal is to be used for displaying a single line of an image frame, wherein each line video signal comprises a blanking signal and a line image signal, and wherein the security processor is configured to add a signal indicative of the relative order of each line image signal as at least part of the security signal into the blanking signal. The relative order signal comprises a signal indicative of a serial number for each line image signal.

Another aspect of the present invention provides a camera comprising: means for generating a usable video signal, the usable video signal being ready for use in a display with substantially little or no signal processing; and means for processing the usable video signal to improve security of the usable video signal for transmission, thereby producing a secured video signal. The camera further comprises means for obtaining an image of a view from the camera, wherein the generation means is configured to generate the usable video signal representing the image. The further comprises means for transmitting the secured video signal to an external device connected to the camera with or without wire. The secured video signal produced by the processing means comprises at least one of an encrypted signal and a security signal. The camera further comprises means for modifying the secured video signal in a serial format.

In the camera described immediately above, the generation means comprises an electrical circuit constructed or programmed to convert an analog signal to a digital signal. The usable video signal comprises an image data segment and a non-image data segment. The usable video signal comprises a blanking section and a video data section. The usable video signal comprises a vertical synchronization signal, a horizontal synchronization signal and an image signal. The usable video signal is in a format selected from the group consisting of International Radio Consultative Committee (CCIR) and Society of Motion Picture and Television Engineers (SMPTE). The processing means comprises means for encrypting at least part of the usable video signal, and wherein the secured video signal comprises an encrypted signal. The usable video signal comprises an image data segment and a non-image data segment, and wherein the encrypting means is to encrypt at least part of the image data segment of the usable video signal. The encrypting means comprises means for separating the at least part of the usable video signal from a remainder of the usable video signal, means for encoding the at least part of the usable video signal, means for bypassing the remainder. The encrypting means further comprises means for supplying at least one security key for use in encoding operation of the encoding means. The encrypting means further comprises means for synchronizing the encoding operation with synchronization signals contained in the usable video signal. The supply means comprises a memory for storing the at least one security key and a circuit for sequentially supplying each security code to the encoding means. The processing means comprises means for adding a security signal to the usable video signal, wherein the secured video signal comprises the usable video signal with the security signal. The usable video signal comprises an image data segment and a non-image data segment, and wherein the adding means is to add the security signal into the non-image data segment of the usable video signal. The processing means is constructed together with the generation means in a single microprocessor.

Another aspect of the present invention provides a video surveillance system. The system comprises: at least one input port configured to receive a video signal transmitted from a source; a processor configured or programmed to process the received video signal to identify one or more irregularities in the transmission of the received signal, wherein the one or more irregularities are selected from the group consisting of interception, alteration, hacking, duplication and replacement of at least part of the secured video signal; and the processor configured or programmed to further process the received video signal to produce a usable video signal, which is ready for use in a digital display with substantially little or no data processing.

The system further comprises a display for displaying video images of the usable digital video signal. The system further comprises a storage device for storing the received video signal before or after the received signal is processed by the processor. The system further comprises a serial-to-parallel converter, wherein the input port is configured to receive the video signal in a serial format, the serial-to-parallel converter is configured to receive the video signal from the input port and transfer the video signal to the processor in a parallel format. The source comprises a camera configured to produce and transmit the video signal, which is a security-improved version of the usable video signal. The received video signal is supposed to include an encrypted signal, wherein the processor is configured to process the received video signal to determine whether the received video signal includes the encrypted signal, and whether the processor is configured to determine existence of one or more transmission irregularities if no encrypted signal is found. The received video signal comprises an encrypted signal, wherein the processor is configured to process the encrypted signal to determine whether the processor can decrypt the encrypted signal, and whether the processor is configured to determine existence of one or more transmission irregularities if the processor determines that the encrypted signal is not in a decryptable form.

In the system, the received video signal comprises an encrypted signal, wherein the processor is configured or programmed to decrypt the encrypted signal to produce the usable video signal. The received video signal comprises an image segment and a non-image segment, and wherein the encrypted signal corresponds to the image segment. The received video signal further comprises a non-encrypted signal, the processor is configure to separate the encrypted signal from the non-encrypted signal, to decrypt the separated encrypted signal to produce a decrypted signal, and to combine the decrypted signal and the non-encrypted signal. The processor is further configured to generate and at least one security key for use in the decryption operation. The processor for the decryption is a specially designed processor for decryption. The received video signal further comprises a non-encrypted signal, wherein the processor is configured to synchronize the decryption with a synchronization signal contained in the non-encrypted signal of the received video signal. The usable video signal configured to be produced by the processor with decryption operation comprises a security signal. The received video signal comprises an encrypted signal representing an image data for a single line of a multiple-line frame, a vertical synchronization signal, a blanking signal and a horizontal synchronization signal; wherein the received signal further comprises at least one security signal incorporated in the blanking signal; wherein the processor is configured to decrypt the encrypted signal to produce the usable video signal; and wherein the processor is further configure to separate the security code from the blanking signal for further processing.

In the system, the received video signal is supposed to include a security signal, wherein the processor is configured to process the received video signal to determine whether the received signal includes the security signal, and wherein the processor is configured to determine existence of one or more transmission irregularities if no security signal is found. The received video signal comprises a security signal comprising one or more sub-signals for use in confirming perfection of transmission of the security signal and, wherein the processor is configured to separate the security signal for further processing. The security signal comprises a sub-signal representing an identification code for the source. The processor is configured to determine whether the identification code from the security signal matches with pre-stored information of the same source. The received video signal comprises signals representing a plurality of image segments, and wherein the security signal comprises a sub-signal indicative of a relative order of each image segment. The processor is configured to determine whether the sub-signal indicative of a relative order matches with a relative order of receipt of the plurality of image segments in the received video signal.

Still another aspect of the present invention provides an apparatus for use in a video surveillance system. The apparatus comprises: means for receiving a video signal transmitted from a source; means for processing the received video signal to identify one or more irregularities in the transmission of the received signal, wherein the one or more irregularities are selected from the group consisting of interception, alteration, hacking, duplication and replacement of at least part of the secured video signal; and means for generating processing the received video signal to produce a usable video signal, which is ready for use in a digital display with substantially little or no data processing.

Still another aspect of the present invention provides a method of improving security of video signal. The method comprises: providing a usable video signal for use in a display with substantially little or no signal processing; and processing the usable video signal to provide a secured video signal comprising at least one of an encrypted signal and a security signal. In the method the provision of the usable video signal is carried out in a camera. The provision of the usable video signal comprises: generating a raw video signal from light entering into the camera; and converting the raw video signal to the usable video signal. The generation of the raw video signal is carried out with use of a charge coupled device (CCD). The raw video signal is in analog form, and wherein the conversion of the raw video signal comprises converting the analog raw video signal to digital form. The method further comprises transmitting the secured video signal via a wired or wireless connection. The transmission is constantly carried out. The transmission is a serial transmission. The transmission is via a coaxial cable. The method further comprises, before transmission, conducting a parallel-to-serial conversion of the secured video signal. The method further comprises providing an audio signal and incorporating the audio signal into the usable video signal. The usable video signal comprises a plurality of line video signals, wherein each line video signal is capable of displaying a line of image on a display, wherein each line video signal comprises a vertical synchronization signal, a horizontal synchronization signal, a blanking signal and a line image signal, and wherein the audio signal is incorporated into the blanking signal.

In the method, the usable video signal is in digital form, and wherein the processing is digital signal processing. The usable video signal is in either analog or digital form. The usable video signal is in a format selected from the group consisting of International Radio Consultative Committee (CCIR) and Society of Motion Picture and Television Engineers (SMPTE). The usable video signal comprises a plurality of line video signals, and wherein each line video signal comprises a vertical synchronization signal, a horizontal synchronization signal, a blanking signal and a line image signal. The security signal is one that can be used for detection of one or more selected from the group consisting of interception, alteration, hacking, duplication and replacement of a signal during transmission thereof. The security signal comprises a signal for a code identifying a source, from which the usable video data originates. The code comprises an identification code for a camera used to generate an original video signal. The security data comprises a signal indicative of a relative order of each video image segment.

In the method, the processing comprising adding the security signal to the usable video signal to provide the secured video signal. The usable video signal comprises a video image segment and a control signal segment, and wherein the addition of a security signal comprises inserting the security signal into the control signal segment. The control signal segment comprises blanking signal and one or more synchronization signals, and wherein the addition of a security signal comprises inserting the security signal into the blanking signal. The usable video signal comprises a plurality of line video signals, wherein each line video signal is capable of displaying a line of image on a display, wherein each line video signal comprises a blanking signal and a line image signal, and wherein the addition of a security signal comprises inserting a signal indicative of the relative order of each line video signal into the blanking signal. The relative order signal comprises a signal indicative of a serial number for each line image signal.

Still in the method, the encrypted signal is one that has to be subject to decryption processing for intended use thereof. The processing comprises encrypting at least part of the usable video signal. The usable video signal comprises a video image segment and a control signal segment, and wherein the encryption comprises encoding at least part of the video image segment. The encrypting comprises separating the at least part of the usable video signal for encryption and then encoding the separated part of the usable video signal. The encrypting further comprises combining the encrypted signal with non-encrypted signal. The control signal segment comprises one or more synchronization signals, and wherein the encryption is initiated by recognition of the one or more synchronization signals. The usable video signal comprises a plurality of line video signals, wherein each line video signal is capable of displaying a line of image on a display, wherein each line video signal comprises a vertical synchronization signal, a horizontal synchronization signal, a blanking signal and a line image signal, and wherein the encrypting comprises: separating the line image signal and the remainders from each line video signal; encoding the line image signal to provide an encoded line image signal; and combining the encoded line image signal and the remainders to provide the secured video signal. The encrypting further comprises: recognizing the vertical and horizontal synchronization signals; and synchronizing the encoding of the line image with the recognition of the vertical and horizontal synchronization signals.

A still further aspect of the present invention provides a method of improving security of video signal for transmission. The method comprises: obtaining a raw video signal requiring a substantial signal processing for use in a display; processing the raw video signal to provide a usable video signal comprising a video image signal and a control signal; and encrypting at least part of the video image signal to provide a secured video signal. The encryption comprises: separating the video image segment from the control signal segment; and encoding the video image segment based on one or more control signals contained in the control signal segment. The provision of the secured video signal further comprises combining the control signal segment and the encrypted video image segment. The method further comprises adding a security signal to the usable video signal. The security signal is inserted into the control signal segment of the usable video signal. The control signal segment is not subject to the encoding. The encryption comprises supplying a plurality of security codes in a predetermined order and encoding the video image segment with use of the plurality of security codes. The supply of a plurality of security codes comprises repeatedly providing a limited number of security codes in an order for the encoding. The control signal segment comprises vertical and horizontal synchronization signals, and wherein the provision of secured video signal comprises supplying a first security code for the encoding upon recognition of the vertical synchronization signal, and initiating continuous supply of the plurality of security codes for the encoding upon recognition of the horizontal synchronization signal.

A still further aspect of the present invention provides a method of producing a usable video signal from a secured video signal. The method comprises: providing a secured video signal comprising either or both of a security signal and an encrypted signal; and processing the secured video signal to produce a usable video signal that is ready for use in a display with substantially little or no signal processing. The provision of the secured video signal comprises receiving the secured video signal transmitted via a wired or wireless connection. The receipt of the secured video signal is via a serial connection, and wherein the provision of the secured video signal comprises conducting a serial-to-parallel conversion of the serially received secured video signal. The provision of the secured video signal comprises retrieving the secured video signal from a storage device storing thereof. The method further comprises displaying a video image of the usable video signal with use of a display. The method further comprises storing the usable video signal in a memory or storage device. The method further comprises archiving the usable video signal before storing. The processing comprising decrypting the encrypted signal. The secured video signal comprises a plurality of secured line video signals, wherein each secured line video signal comprises either or both of the security signal and the encrypted signal, wherein the processing comprises separating the encrypted signal from each secured line video signal, and wherein the processing further comprises decrypting the encrypted signal. The processing comprising checking whether the secured video signal provided has been subject to one or more selected from the group consisting of interception, alteration, hacking, duplication and replacement.

A still further aspect of the present invention provides a method of operating a video surveillance system. The method comprises: receiving a video signal transmitted from a source; identifying one or more irregularities in the transmission of the received signal, wherein the one or more irregularities are selected from the group consisting of interception, alteration, hacking, duplication and replacement of at least part of the secured video signal; and processing the received video signal to produce a usable video signal, which is ready for use in a digital display with substantially little or no data processing. The method further comprises storing the received video signal before or after the received signal is processed by the processor. The method further comprises conducting a serial-to-parallel conversion of the received video signal. The received video signal is supposed to include an encrypted signal, wherein the identification comprises determining whether the received video signal includes the encrypted signal. The received video signal comprises an encrypted signal, wherein the identification comprises determining whether the processor can decrypt the encrypted signal. The received video signal comprises an encrypted signal, wherein the processing comprises decrypting the encrypted signal to produce the usable video signal. The received video signal comprises an image segment and a non-image segment, and wherein the encrypted signal corresponds to the image segment. The received video signal further comprises a non-encrypted signal, the decrypting comprises separating the encrypted signal from the non-encrypted signal, decoding the separated encrypted signal to produce a decrypted signal, and combining the decrypted signal and the non-encrypted signal.

In the method of operating a video surveillance system, the decrypting comprises generating at least one security key for use in the decoding. The received video signal further comprises a non-encrypted signal, wherein the processing comprises synchronizing the decryption with a synchronization signal contained in the non-encrypted signal of the received video signal. The usable video signal produced by the decryption comprises a security signal. The received video signal comprises an encrypted signal representing an image data for a single line of a multiple-line frame, a vertical synchronization signal, a blanking signal and a horizontal synchronization signal; wherein the received signal further comprises at least one security signal incorporated in the blanking signal; wherein the decryption decrypts the encrypted signal to produce the usable video signal; and wherein the processing further comprises separating the security code from the blanking signal for further processing. The received video signal is supposed to include a security signal, wherein the identification comprises determining whether the received signal includes the security signal. The received video signal comprises a security signal comprising one or more sub-signals for use in confirming perfection of transmission of the security signal and, wherein the identification comprises separating the security signal for further processing. The security signal comprises a sub-signal representing an identification code for the source. The identification further comprises determining whether the identification code from the security signal matches with pre-stored information of the same source. The received video signal comprises signals representing a plurality of image segments, and wherein the security signal comprises a sub-signal indicative of a relative order of each image segment. The identification comprises determining whether the sub-signal indicative of a relative order matches with a relative order of receipt of the plurality of image segments in the received video signal.

A still further aspect of the present invention provides a video data stream. The video data stream is transmitted via a wireless or wired connection in a video surveillance system, the data stream comprising a plurality of line video signals, each line video signal comprising a vertical synchronization signal, a blanking signal, a horizontal synchronization signal and a line image signal, wherein at least part of the line image signal is in an encrypted form. The video data stream further comprises audio data, wherein the audio data are inserted in the blanking signal. The video data stream further comprises source identification data for identifying a source of the video data stream. The source identification data are inserted in the blanking signal. The video data stream further comprises sequence data for indicating relative order of each line video signal. The sequence data are inserted in the blanking signal. The video data stream is transmitted serially.

A still further aspect of the present invention provides a method of generating the video data stream described above. The method comprises: providing a usable video signal for use in a display with substantially little or no signal processing; encrypting the at least part of the line image signal of the usable video signal; combining the encrypted part of the line image signal and the remainder of the usable video signal; and transmitting the combined signals.

Another aspect of the present invention provides a security system including a camera means for generating a plurality of video signals corresponding to images and converting the video signals into a plurality of usable digital video signals, a receiving unit for displaying the usable digital video signals on a monitor or storing them in a storage device in a compressed format, and a cable connected to the camera means and the receiving unit for transmitting the usable digital video signals. The camera means converts the plurality of the generated usable digital video signals into serial digital video signals and then successively transmits the serial digital video signals to the receiving unit via the cable; and the receiving unit successively converts the converted serial digital video signals received via the cable into a plurality of usable digital video signals, stores the usable digital video signals in the storage device in the compressed format and outputs them to a video output device. The security system of the present invention can prevent influence of loss and noise of data during transmission of digital signals and transmit high quality images by converting the usable digital video signals into serial data and transmitting the serial data, and can also be manufactured at a low cost since additional D/A and A/D converters are not required any longer for the camera and the receiving unit upon transmission of the analog video signals.

Preferably, the camera means inserts security data for identifying specific camera means into blanking intervals of the plurality of usable digital video signals, converts the plurality of usable digital video signals into which the security data are inserted into serial digital video signals, and transmits successively the serial digital video signals to the receiving unit via the cable; and the receiving unit successively converts the converted serial digital video signals received via the cable into a plurality of usable digital video signals into which the security data are inserted, extracts synchronization signals and the inserted security data from the plurality of usable digital video signals into which the security data are inserted, confirms whether the extracted security data correspond to the specific camera means, and stores the plurality of usable digital video signals in the storage device in the compressed format and outputs them to the video output device.

Preferably, the camera means includes a charge coupled device (CCD), a digital signal processor (DSP), and a parallel/serial signal converter, the CCD generates the plurality of video signals corresponding to the images, the digital signal processor converts the generated plurality of video signals into the plurality of usable digital video signals and inserts the security data for identifying the specific camera means into the blanking intervals of the plurality of usable digital video signals, the parallel/serial signal converter converts the plurality of usable digital video signals into which the security data are inserted into the serial digital video signals and transmits successively the serial digital video signals to the receiving unit via the cable; and the receiving unit includes a serial/parallel signal converter, a data compressor and a microprocessor, the serial/parallel signal converter converts successively the converted serial digital video signals received via the cable into the plurality of usable digital video signals into which the security data are inserted, the data compressor stores the plurality of usable digital video signals in the storage device in the compressed format, and the microprocessor controls the serial/parallel signal converter and the data compressor, extracts the synchronization signals and the inserted security data from the plurality of usable digital video signals into which the security data are inserted, confirms whether the extracted security data correspond to the specific camera means and outputs the plurality of usable digital video signals to the video output device.

The security data may further include time stamp data indicating a sequence of the video signals. In the security system of the present invention, the cable may be a coaxial cable. Preferably, the camera means further includes a microphone for converting voice signals to electrical signals, the digital signal processor further inserts voice data into the blanking intervals of the plurality of usable digital video signals into which the security data are inserted; and the microprocessor of the receiving unit further extracts the voice data from the plurality of usable digital video signals into which the security data are inserted, and stores the extracted voice data in the storage device.

Since the security system inserts and transmits security data for identifying specific cameras in the usable digital video signals, input of faked video signals or alteration of video signals by an external intruder can be prevented. In addition, the coaxial cable in the conventional security system employing the camera can be reused without exchange with a separate cable for transmitting digital data.

According to another aspect of the present invention, there is provided a method of encrypting digital video signals of a security camera including a digital signal processor for converting raw digital video signals into usable digital video signals. The method comprises a video signal separation and supply step of separating the digital video signals, which have been inputted from the digital signal processor to a video data distributor, into vertical synchronization signals, horizontal synchronization signals, and data in active scanning line intervals, and supplying the vertical and horizontal synchronization signals to a key data supplier and the data in the active scanning line intervals to a video data encryption device; an encryption key data supply step of selecting specific encryption key data among a plurality of encryption key data unique to the security camera and supplying the selected encryption key data to the video data encryption device in order to initialize the video data encryption device if the vertical synchronization signals are inputted into the key data supplier with the plurality of encryption key data stored therein, and sequentially supplying the plurality of encryption key data to the video data encryption device if the horizontal synchronization signals are inputted; and an encryption step of encrypting the data in the active scanning line intervals, which have been separated and inputted, within the video data encryption device by using the inputted encryption key data.

Preferably, in the method of encrypting the digital video signals of the camera according to the present invention, the encryption step further comprises an encryption key data shift step of shifting bits of the supplied encryption key data to be circulated whenever the data in the active scanning line intervals separated by the video data distributor are inputted. Preferably, in the shift step, the encryption key data are shifted to be circulated by selecting values of two bits at specific positions of the encryption key data, performing a logical operation of the selected values, and setting the logically operated value to a value of bit at a specific position.

This aspect of the present invention prevents an external intruder from viewing the contents of the video signals transmitted from the security camera even though the video signals are hacked by the intruder. Since only data in the active scanning line intervals of the usable digital video signals outputted from the digital signal processor of the camera are encrypted, the amount of data to be encrypted is reduced so that a mass of video signals can be transmitted as digital signals, and security can be ensured even though the video signals are hacked during the transmission thereof.

According to another aspect of the present invention, there is provided a camera with an encryption means for encrypting digital video signals in the camera by using the aforementioned encryption method. The security camera with a charge coupled device and a digital signal processor according to the present invention comprises an encryption means for encrypting digital video signals outputted from the digital signal processor. The encryption means includes a video signal distributor for receiving the digital video signals from the digital signal processor, separating the digital video signals into vertical synchronization signals, horizontal synchronization signals, data in scanning line blanking intervals, and data in active scanning line intervals, and outputting them; a key data supplier for storing a plurality of encryption key data unique to the security digital camera, selecting specific encryption key data among the plurality of encryption key data and outputting the selected encryption key data if the vertical synchronization signals are inputted, and sequentially outputting the plurality of encryption key data if the horizontal synchronization signals are inputted; and a video data encryption device for receiving the encryption key data and the data in the active scanning line intervals, encrypting the data in the active scanning line intervals by using the encryption key data, and outputting the encrypted data.

Preferably, in the camera with the encryption means according to the present invention, the video data encryption device comprises a shift register unit for shifting bits of the supplied encryption key data to be circulated whenever the data in the active scanning line intervals separated by the video data distributor are inputted, and an encryption operation unit for encrypting the inputted data in the active scanning line intervals by using the encryption key data shifted by the shift register unit, and outputting the encrypted data. Preferably, in the camera with the encryption means according to the present invention, the shift register unit further comprises a logical circuit which can select values of two bits at specific positions of the encryption key data and set them to values of bits at specific positions when the inputted encryption key data are shifted.

The camera with the encryption means according to this aspect of the present invention may further comprises a parallel to serial converter for receiving the data in the scanning line blanking intervals outputted from the video signal distributor and the encrypted data in the active scanning line intervals outputted from the video data encryption device, converting the received data into serial data, and outputting the serial data. Preferably, in the camera with the encryption means according to the present invention, the digital signal processor additionally inputs time stamp data having circulative, consecutive values into blanking regions of the scanning line blanking intervals of the digital video signals and then outputs them.

This aspect of the present invention provides a camera generating encrypted digital video signals so as to prevent an external intruder from viewing the contents of the video signals transmitted from the security camera even though the video signals are hacked by the intruder. Since the camera of has the encryption circuit therein and encrypts only data in active scanning line intervals of usable digital video signals outputted from the digital signal processor of the camera, the amount of data to be encrypted is reduced so that a mass of video signals can be transmitted as digital signals, and security can be ensured even though the video signals are hacked during the transmission thereof. Further, since the encrypted digital video signals can be converted and transmitted serially, there is an advantage in that the digital video signals can be transmitted using a conventional coaxial cable. Furthermore, since the digital video signals can be transmitted, it is possible to provide image quality superior to that of a conventional camera for transmitting video signals in analog signals. Furthermore, the production costs of the camera can be reduced because the A/D and D/A converters are not required.

According to a further aspect of the present invention, there is provided a security system which has a camera for transmitting encrypted digital video signals, can receive and decrypt the transmitted digital video signals, output them to a monitor, and compress and store them. The security system of the present invention includes a security camera having a charge coupled device and a digital signal processor, a transmission means through which digital video signals from the camera are transmitted, and a receiving unit having a microprocessor for receiving the digital video signals transmitted through the transmission means and outputting the received digital video signals to a monitor and a data compression unit for compressing and storing the signals in a storage device. The camera further includes an encryption means for encrypting the digital video signals outputted from the digital signal processor. The encryption means includes a video signal distributor for receiving the digital video signals from the digital signal processor, separating the digital video signals into vertical synchronization signals, horizontal synchronization signals, data in scanning line blanking intervals and data in active scanning line intervals, and outputting them; a key data supplier for storing a plurality of encryption key data unique to the security digital camera, selecting specific encryption key data among the plurality of encryption key data and outputting the selected encryption key data if the vertical synchronization signals are inputted, and sequentially outputting the plurality of encryption key data if the horizontal synchronization signals are inputted; and a video data encryption device for receiving the encryption key data and the data in the active scanning line intervals, encrypting the data in the active scanning line intervals by using the encryption key data, and outputting the encrypted data. The receiving unit further includes a decryption device for decrypting the encrypted digital video signals transmitted through the transmission means and outputting the decrypted digital video signals to the microprocessor. The decryption means includes a video signal distributor for receiving the encrypted digital video signals, separating the digital video signals into vertical synchronization signals, horizontal synchronization signals, and encrypted data in active scanning line intervals, and outputting the separated signals and data; a key data supplier for storing a plurality of decryption key data unique to the security digital camera, selecting specific decryption key data among the plurality of decryption key data and outputting the selected decryption key data if the vertical synchronization signals are inputted, and sequentially outputting the plurality of decryption key data if the horizontal synchronization signals are inputted, and a video data decryption device for receiving the decryption key data and the encrypted data in the active scanning line intervals, decrypting the data in the active scanning line intervals by using the decryption key data, and outputting the decrypted data. The microprocessor receives the data in the scanning line blanking intervals outputted from the video signal distributor of the receiving unit and the decrypted data in the active scanning line intervals outputted from the video data decryption device, performs mapping from the data to the video signals, and outputs them.

Preferably, in the security system of the present invention, the digital signal processor additionally inputs time stamp data having circulative, consecutive values into blanking regions of the scanning line blanking intervals of the digital video signals and then outputs them, and the microprocessor further performs a function of consecutively extracting the time stamp data from the blanking regions of the scanning line blanking intervals into which are consecutively inputted and outputting a warning signal if the extracted values are not consecutive. Preferably, in the security system of the present invention, the camera further includes a parallel/serial converter for receiving the data in the scanning line blanking intervals outputted from the video signal distributor and the encrypted data in the active scanning line intervals outputted from the video data encryption device, converting the received data into serial data, and outputting the serial data, the transmission means is a coaxial cable through which the serial data can be transmitted, and the receiving unit further includes a serial/parallel converter for converting the serial data transmitted through the coaxial cable into parallel data and supplying the parallel data to the video signal distributor of the receiving unit.

According to this aspect of the present invention, digital video signals are encrypted and transmitted serially in real time and then decrypted in real time to be outputted to a monitor and to be compressed and stored, thereby preventing an external intruder from hacking the transmitted video signals and avoiding the loss and noise of signals produced in analog transmission of the video signals. According to the security system of the present invention, since the digital video signals are transmitted, the loss of the signals can be reduced. Thus, high quality images can be transmitted in real time. Further, since the time stamp data allowing a check on the continuity of the transmitted video signals are transmitted together with the encrypted digital video signals, it is possible to recognize a state where any other video signals are inputted from the outside or the camera is damaged. In addition, in the security system of the present invention, since the digital video signals can be transmitted serially by using the coaxial cables used in the conventional security system, the installation costs thereof can be reduced.

### BRIEF DESCRIPTION OF THE DRAWINGS

The features of the present invention will become apparent from the following description of preferred embodiments given in conjunction with the accompanying drawings, in which:

FIG. 1 is a schematic view showing a configuration of a security system having a camera according to embodiments of the present invention;

FIG. 2 is a block diagram of a security system according to a first preferred embodiment of the present invention;

FIG. 3 is an exemplary data format of a video signal outputted from a digital signal processor for a single line display in accordance with the first preferred embodiment illustrated in FIG. 2;

FIG. 4 is a block diagram showing a configuration of an encryption unit of the camera of FIG. 2;

FIG. 5 is a block diagram showing a configuration of a video data encryption device of FIG. 4;

FIG. 6 is a block diagram of a parallel to serial (P/S) converter of FIG. 2;

FIG. 7 is a flowchart illustrating a method of encrypting the digital video signals in the camera of FIG. 2;

FIG. 8 is a block diagram showing a configuration of a decryption unit of a receiving unit of FIG. 2;

FIG. 9 is an exemplary data format of a video signal outputted from a digital signal processor for a single line display in a second preferred embodiment;

FIG. 10 is a block diagram showing a configuration of a conventional security system for transmitting video signals as analog signals.

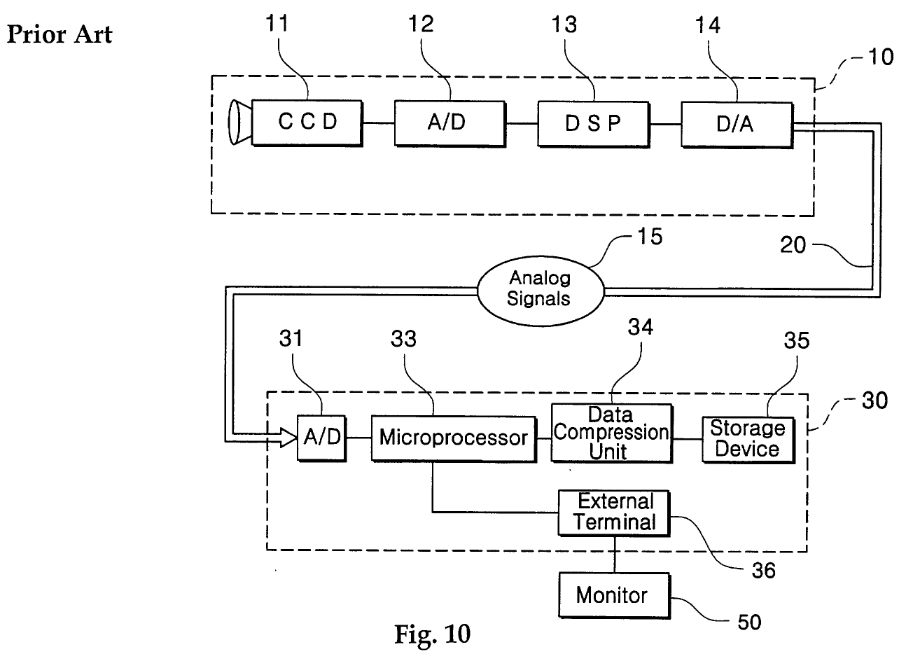

FIG. 11 is a block diagram showing a configuration of a conventional digital video signal transmission system;

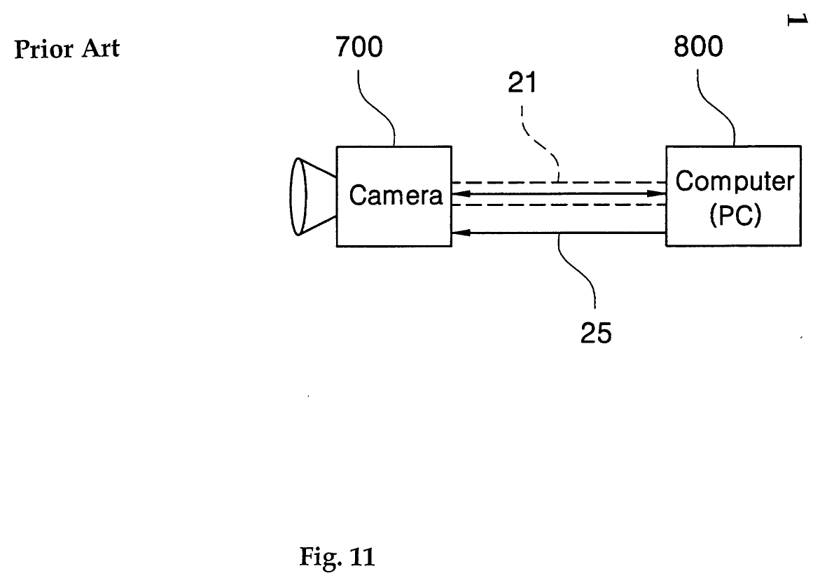

FIG. 12 is a schematic circuit diagram of the digital camera of FIG. 10; and

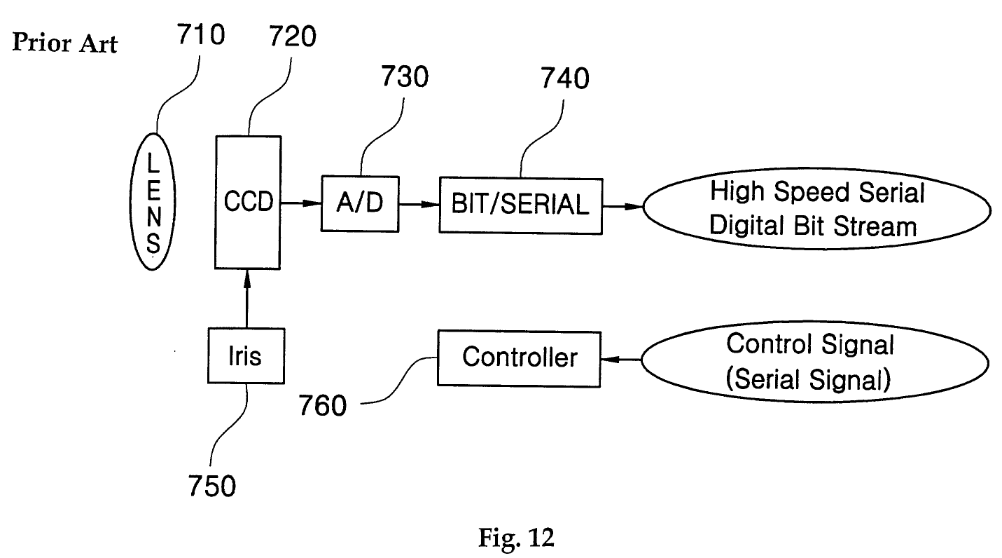

FIG. 13 is a schematic circuit diagram of a digital video signal receiving unit of FIG. 10.

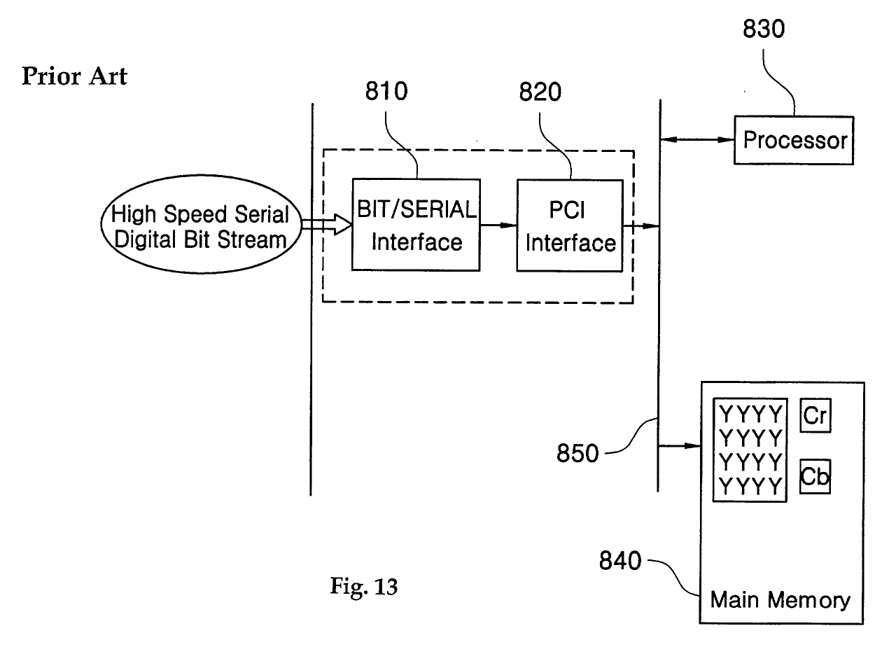

### DETAILED DESCRIPTION OF PREFERRED EMBODIMENTS

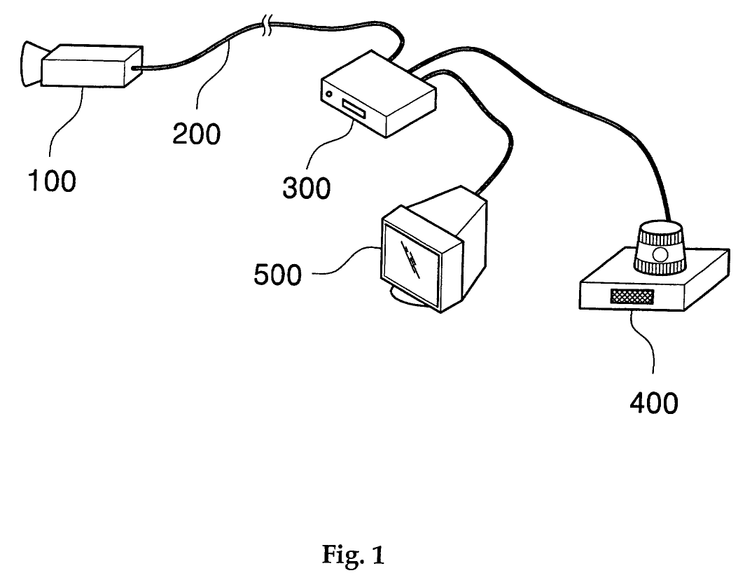

Now preferred embodiments of the present invention will be explained in detail with reference to the accompanying drawings. FIG. 1 illustrates a configuration of a security system according to preferred embodiments of the present invention. The security system according to the preferred embodiments of the present invention comprises a digital camera 100 for generating a plurality of video signals corresponding to images, converting the signals into usable digital video signals, encrypting the digital video signals, and transmitting the encrypted signals to a transmission means 200; the transmission means 200 through which the encrypted digital video signals are transmitted; and a receiving unit 300 for decrypting the encrypted digital video signals transmitted through the transmission means 200 and then outputting the decrypted signals to an external monitor 500 or storing the decrypted signals into a storage device. Preferably, the security system further comprises a warning device 400 for receiving a warning signal from the receiving unit and informing an operator of the system that the encrypted video signals have been altered.

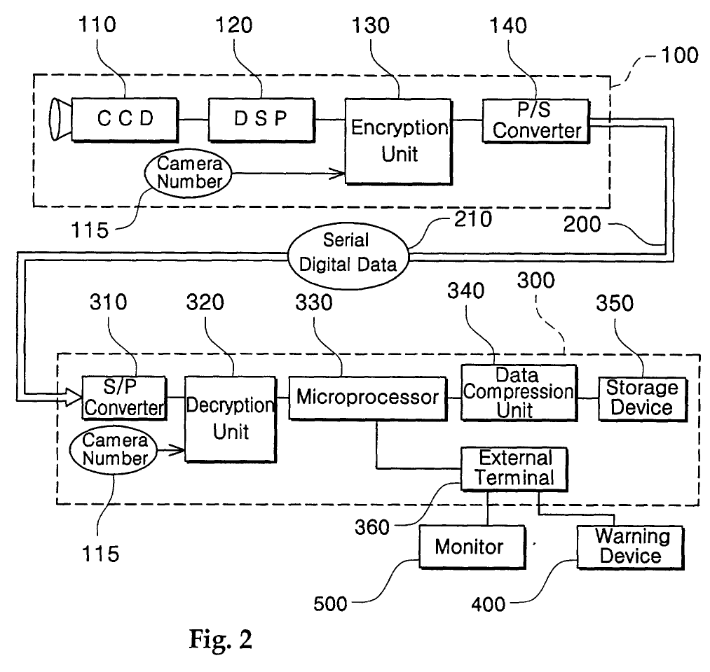

FIG. 2 is a block diagram illustrating the configuration of a security system having the camera with the encryption circuit according to a first preferred embodiment of the present invention. The digital camera 100 includes a charge coupled device (CCD) 110, a digital signal processor (DSP) 120, an encryption unit 130, and a parallel to serial converter (P/S converter) 140. The CCD 110 outputs the images, which have been captured through a lens, as the video signals. The DSP 120 performs sampling and quantization of the outputted video signals, encodes them into a video format according to the recommendations of the CCIR (International Radio Consultative Committee) or SMPTE (Society of Motion Picture and Television Engineers), and converts the encoded signals into the usable digital video signals. The encryption unit 130 performs the encryption of data in active scanning line intervals of the usable digital video signals outputted from the DSP 120 by using key data generated in the form of values used for identifying specific cameras (preferably, camera number 115). The P/S converter 140 converts the encrypted digital video signals into serial digital data 210 and transmits the converted data to the transmission means 200. If necessary, the DSP 120 may be configured to determine whether the encrypted digital video signals have been altered during the transmission thereof by inserting a series of circulative time stamp data into blanking intervals of the usable digital video signals.

The receiving unit 300 comprises a serial to parallel converter (S/P converter) 310, a decryption unit 320, a microprocessor 330, a data compression unit 340, and the storage device 350. In addition, the receiving unit 300 further comprise an external terminal 360 through which the microprocessor 330 can output the digital video signals to the outside of the system. Peripheral devices such as the monitor 500 and the warning device 400 for generating a warning sound may be connected to the external terminal 360. The S/P converter 310 converts the encrypted serial digital video signals 210 received from the camera 100 into encrypted parallel digital signals. The decryption unit 320 decrypts the encrypted parallel digital video signals and then transmits the signals to the microprocessor 330. The microprocessor 330 causes the decrypted parallel digital video signals to be mapped according to scanning lines and to be outputted. The data compression unit 340 compresses the video signals outputted from the microprocessor 330, and the storage device 350 stores the compressed data therein. In a case where the time stamp data are inserted into the encrypted digital video signals, the microprocessor 330 may be configured to extract time stamp values of a series of digital video signals decrypted by the decryption unit 320 and to output the warning signal when the time stamp values are not consecutive.

Further, the digital camera 100 may include a microphone (not shown) for converting voice signals into electrical signals. In such a case, the voice signals are inserted into the blanking intervals of the usable digital video signals in the DSP 120 of the digital camera 100. In addition, the microprocessor 330 of the receiving unit 300 performs a function of further extracting the inserted voice signals from the usable digital video signals and then outputting the extracted voice signals.

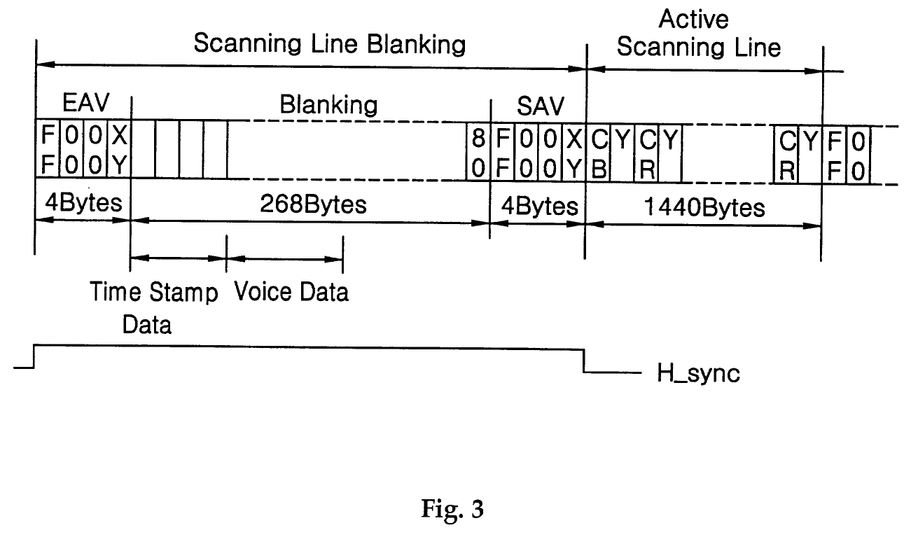

FIG. 3 shows a data format of digital video signals outputted from a digital signal processor of FIG. 2. The data format of the digital video signal, which is shown in FIG. 3, is a data format of the usable digital video signals employing a chroma format 525/60 scanning line system, which are produced as the DSP 120 processes the video signals generated in the CCD 110. The data format of the usable digital video signals consists of scanning line blanking intervals, which have horizontal synchronization signal (H sync) and vertical synchronization signal (V sync) data, and active scanning line intervals including information on color difference signals Cr and Cb and a luminance signal Y. This data format shows digital data of the video signals for one line. In this embodiment, the scanning line blanking interval of 276 bytes consists of an EAV (End of Active Video) of 4 bytes, an SAV (Start of Active Video) of 4 bytes, and a blanking portion of 268 bytes. Further, the active scanning line interval is of 1440 bytes. Video signal data constituting the active scanning line interval are digital video data, which were produced by the DSP 120 converting the video signals generated in the CCD 110 to a format which can be directly displayed on a monitor.

The DSP 120 of the present embodiment inserts the time stamp data of 4 bytes into a blanking region of the scanning line blanking interval. The time stamp data are values indicating a successive sequence for each line of video frames processed by the DSP 120. Since each of the time stamp data has 4 bytes, the time stamp data can be sequentially circulated such that their values are sequentially increased from a value of 00 00 00 00 to a value of FF FF FF FF and then again revert to the value of 00 00 00 00. Therefore, faking of digital video signals to be transmitted or insertion of altered videos after removal of a specific camera by an external intruder can be easily detected. Although the time stamp data have a size of 4 bytes in this embodiment, it is not limited thereto but can be set as proper different sizes depending on the kinds of systems.

In addition, voice data from a microphone (not shown) may be digitized and inserted into the blanking region. In the case of insertion of the voice data, the voice data are preferably inserted according to an audio digital format employed by AES (Audio Engineering Society) and EBU (European Broadcasting Union). The digital audio data can be inserted into a proper location of the blanking region remaining after insertion of the time stamp data. Since a method of inserting the time stamp data or the digital audio data into the blanking region can be easily performed by those skilled in the art, the detailed description of the method will be omitted.

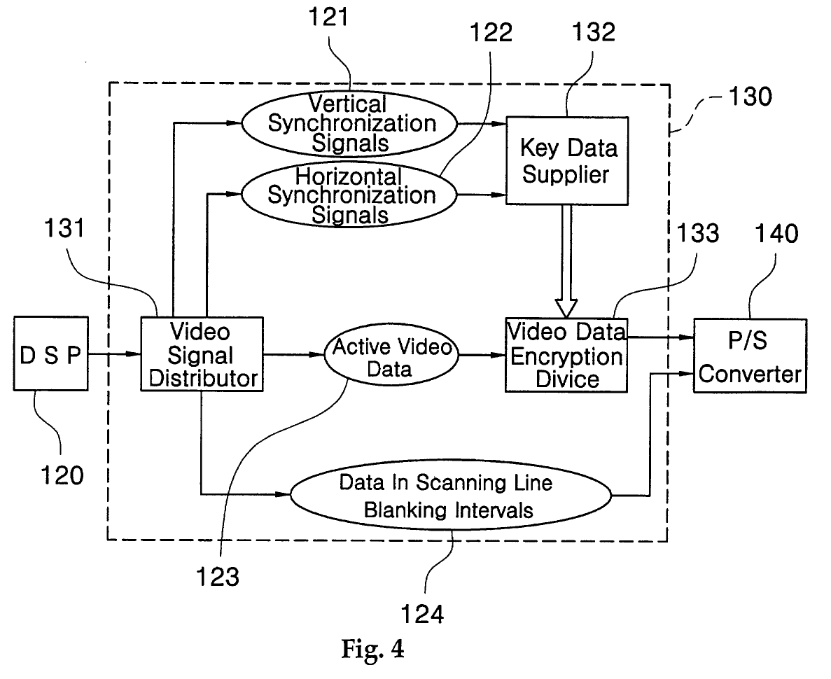

FIG. 4 is a block diagram showing the configuration of the encryption unit 130 for implementing an encryption method. The encryption unit 130 according to the present preferred embodiment includes a video signal distributor 131, a key data supplier 132 and the video data encryption device 133. The video signal distributor 131 receives the digital video signals from the DSP 120. Then, the signal distributor reads the horizontal synchronization signals 122, the vertical synchronization signals 121, the data 124 in the scanning line blanking intervals, and the data 123 in the active line intervals from the received signals, and outputs them respectively. The key data supplier 132 stores a plurality of encryption key data that are generated, based on the unique camera numbers 115 assigned to the cameras, through the encryption algorithm embedded beforehand.

The encryption key data are transmitted to the video data encryption device so that they can be used for encrypting active video data. If the vertical synchronization signals are inputted from the video signal distributor 131, the key data supplier 132 selects the specific encryption key data among the plurality of stored encryption key data and supplies the selected encryption key data to the video data encryption device 133. Alternatively, if the horizontal synchronization signals are inputted, the key data supplier 132 sequentially supplies the plurality of stored encryption key data to the video data encryption device 133. The video data encryption device 133 encrypts the data in the active line intervals inputted from the video signal distributor 131 with the encryption key data inputted from key data supplier 132, and then outputs the encrypted data to the P/S converter 140. The encryption at the encryption device 133 can be carried out in accordance with any encryption algorithm for the purpose of the present invention. In addition, the video signal distributor 131 transmits the data 124 in the scanning line blanking intervals, which need not be encrypted, directly to the P/S converter 140. In other words, after receiving the digital video signals, the video signal distributor 131 causes all the data 124 in the blanking intervals to be directly transmitted to the P/S converter 140 when the horizontal synchronization signals are in active state (high level), whereas it causes the data 123 in the active line intervals to be transmitted to and encrypted in the video data encryption device 133 when the horizontal synchronization signals are not in active state (low level) as the state of the horizontal synchronization signal shown in FIG. 3. The video data encryption device 133 transmits the encrypted data to the P/S converter 140. Thus, the P/S converter 140 sequentially receives the digital video signals having the same order before encryption and converts them into the serial data so that the converted data can be transmitted to a next stage.

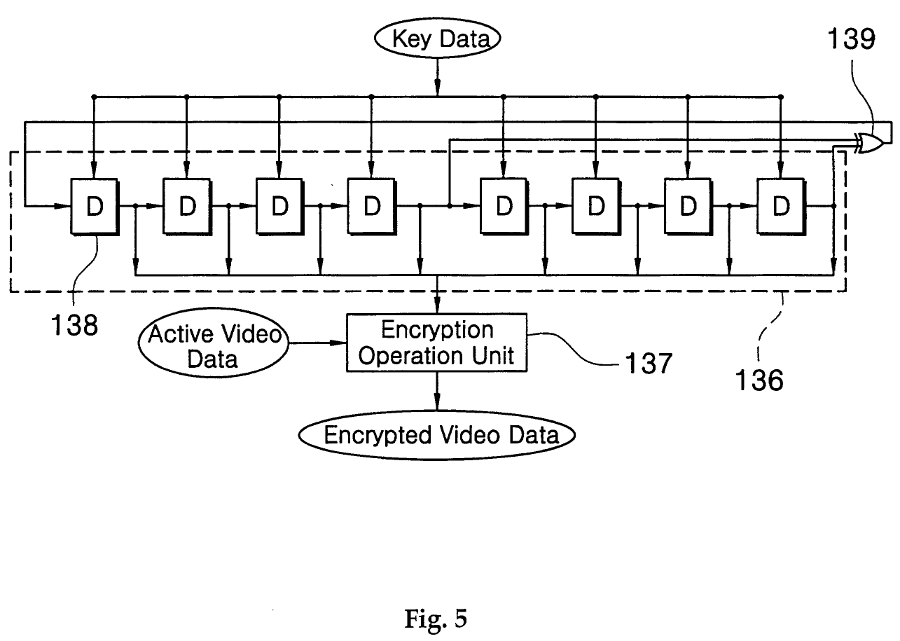

FIG. 5 illustrates an exemplary configuration of a video data encryption device 133 of FIG. 4. The video data encryption device 133 according to the present embodiment comprises a shift register 136 and an encryption operation unit 137. The shift register provides the encryption operation unit with regularly modified encryption key data so that the decryption thereof can be more difficult even though the digital video signals are hacked during the transmission thereof. The shift register 136 is configured by connecting D flip-flop circuits 138 in series with one another such that the data can be circulated and shifted as shown in FIG. 5. The number of the D flip-flop circuits 138 may be determined according to the size of the data to be encrypted at one time. In the present embodiment, eight (8) D flip-flop circuits 138 are employed. The encryption key data of 8 bits inputted into the shift register 136 are shifted in synchronism with a clock for supplying the encryption operation unit 137 with active video data corresponding to the data in the active line intervals. In addition, in order to make it more difficult to decrypt the data, the shift register 136 may be further provided with a logical circuit for allowing an extracted and logically operated output value of the plurality of D flip-flop circuits 138 to be inputted into a specific D flip-flop circuit. In the present embodiment, the logical circuit for performing an exclusive OR operation of the output values of the fourth and eighth D flip-flop circuits and inputting the logically operated value into the first D flip-flop circuit is employed.

Now, the operations of the shift register 136 and the encryption operation unit 137 will be explained. If the vertical synchronization signals 121 are inputted into the key data supplier 132, the key data supplier 132 supplies a specific encryption key data to the shift register 136 and causes the shift register to be initialized. Then, if the horizontal synchronization signals 122 are inputted into the key data supplier 132, the key data supplier 132 causes the encryption key data to be sequentially supplied to the shift register 136. The shift register 136 provides the values of the transmitted encryption key data to the encryption operation unit 137, and the encryption operation unit 137 causes the active video data 123 to be encrypted into the encryption key data according to the predetermined logical operation algorithm. The encryption key data inputted into the shift register 135 are shifted in synchronism with the clock for supplying the encryption operation unit 137 with active video data 123, and the shifted key data are used to encrypt the next active video data 123. If the next horizontal synchronization signals 122 are provided to the key data supplier 132 after the active video data in one line are fully encrypted, the key data supplier 132 causes the next encryption key data to be transmitted to and consecutively encrypted within the shift register and then the video data in one frame to be encrypted until the next vertical synchronization signals 121 are inputted. The video data encryption device 133 causes the above operations to be repeated by means of the clock for supplying the vertical and horizontal synchronization signals and the active video data and the digital video signals to be consecutively encrypted.

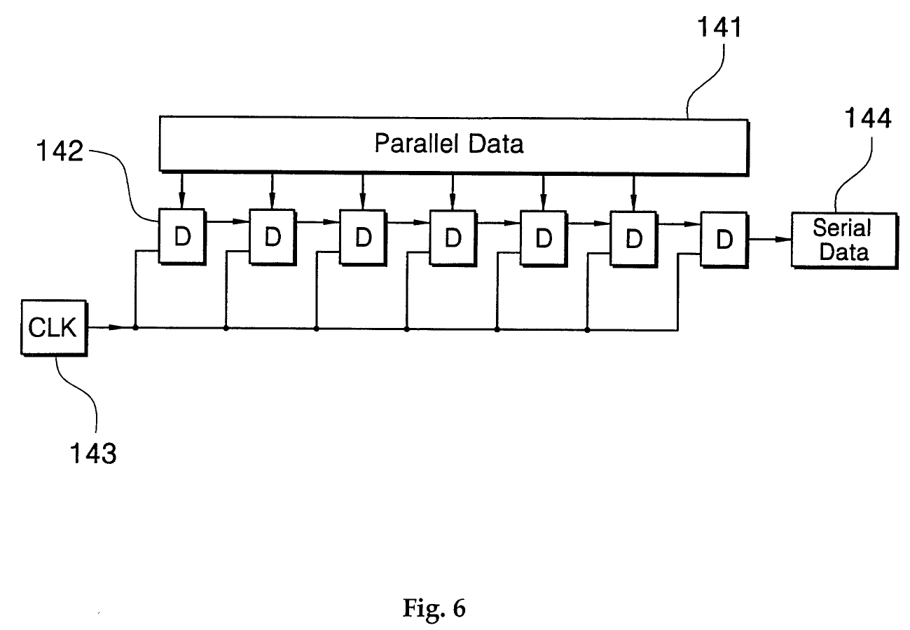

FIG. 6 illustrates an exemplary construction of a parallel to serial (P/S) converter 140 of FIG. 2. The usable digital video signals encrypted as described above are converted into serial digital data by the P/S converter 140 and then transmitted to the receiving unit 300 via the transmission means 200. As shown in FIG. 4, the data 124 in the scanning line blanking intervals and the encrypted active video data are inputted sequentially and in parallel to one another into the P/S converter 140 in which they are in turn converted into the serial signals.

As shown in FIG. 6, the P/S converter 140 includes a plurality of D flip-flops 142 connected with one another in series. Parallel data 141 latched at each of input terminals of the plurality of D flip-flops can be converted into serial data 144 as the parallel data 141 are outputted sequentially by a clock CLK 143. In this embodiment, since data corresponding to one digital scanning line are 1,728 bytes (synchronization signal (EAV, SAV)+blanking+active scanning line), conversion time of data corresponding to one digital scanning line when one clock is about 37 ns (27 MHz) is 37×1728=about 64 μs. Therefore, when digital data corresponding to video signals of one frame are 1728 bytes×525 scanning lines, conversion time of digital video signals of one frame in an interlaced scanning system is 64 μs×525=about 33 ms.

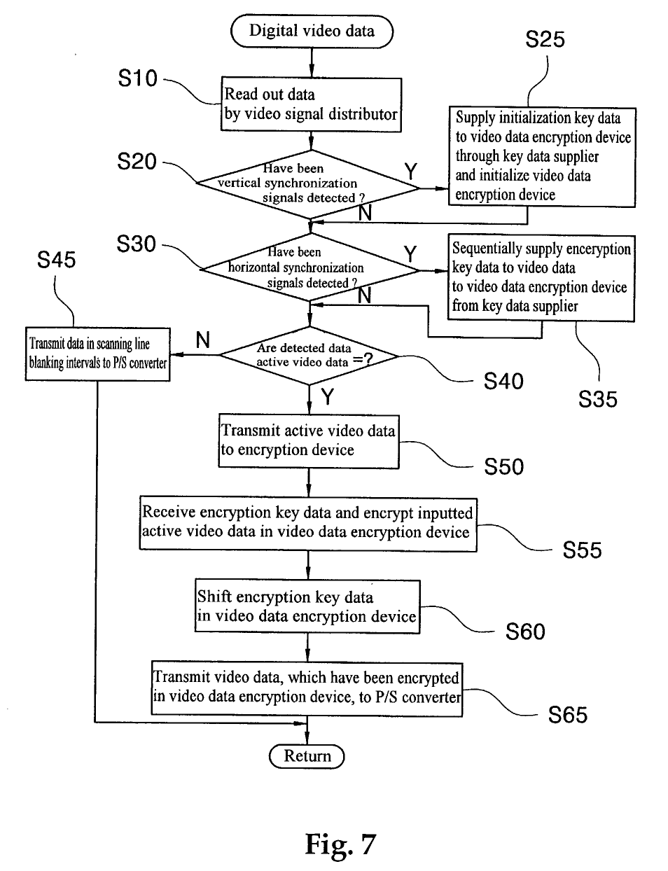

FIG. 7 is a flowchart illustrating a method of encrypting the digital video signals in the camera of FIG. 2. The method of encrypting the digital video signals according to the present invention is implemented such that the video signal distributor 131 reads both the data in the scanning line blanking intervals and the data in the active scanning line intervals from the digital video signals inputted from the digital signal processor 120 (S10). In a case where the vertical synchronization signals 121 in the scanning line blanking intervals-are detected (S20), the video data encryption device 133 is initialized by supplying the initialization key data stored in the key data supplier 132 to the video data encryption device 133 (S25). Then, in a case where the horizontal synchronization signals 122 in the scanning line blanking intervals are detected (S30), the plurality of encryption key data stored in the key data supplier 132 are sequentially supplied to the video data encryption device 133 (S35). Further, in a case where the detected data are the active video data in the active scanning line intervals (S40), the active video data 123 are supplied to the video data encryption device 133 (S50). Otherwise, the data 124 in the scanning line blanking intervals are supplied to the P/S converter 140 (S45).

Then, the video data encryption device 133 encrypts the separated and inputted data in the active scanning line intervals according to the predetermined logical operation with the inputted encryption key data (S55). Then, the inputted encryption key data are shifted by the shift register 136 having the logical operation circuit 139 (S60), and the encrypted data in the active scanning line intervals are transmitted to the P/S converter (S65).

Thereafter, the encryption key data, which have been shifted and modified in step S60, are used to encrypt the subsequent data in the active scanning line intervals according to the predetermined logical operation. The data in the active scanning line intervals, which have been encrypted by using the modified encryption key data, are sequentially transmitted to the P/S converter 140. At this time, the encryption key data are consecutively shifted and modified until the next horizontal synchronization signals are detected, and the modified encryption key data causes the inputted data in the active scanning line intervals to be sequentially encrypted. Then, if the horizontal synchronization signals 122 are detected, the next encryption key data stored in the key data supplier 132 are supplied to the video data encryption device 133 as illustrated in step S35. Further, if the encryption of arbitrary field is completed by using the sequentially inputted encryption key data and the vertical synchronization signals 121 of the next field are inputted as illustrated in step S20, the process of again initializing the video data encryption device 133 is repeatedly performed.

When the serial digital data converted as above are transmitted via the transmission means 200, i.e. the coaxial cable, connected to the receiving unit 300, the coaxial cable is sufficient if it has a characteristic resistance of 75 Ω and a bandwidth of 500 Mbps, and the serial digital data can be transmitted via the coaxial cable used in the conventional security system employing the camera. In this embodiment, when digital data of 30 fps (frame per second) having 720×480 pixels are transmitted, the amount of data to be transmitted is 720×480 (pixels)×8 (bits)×2×30 (fps)=165,888,000 (bps)≈166 Mbps. Therefore, it is possible to transmit digital data having frames larger than 720×480 (pixels) via the coaxial cable.

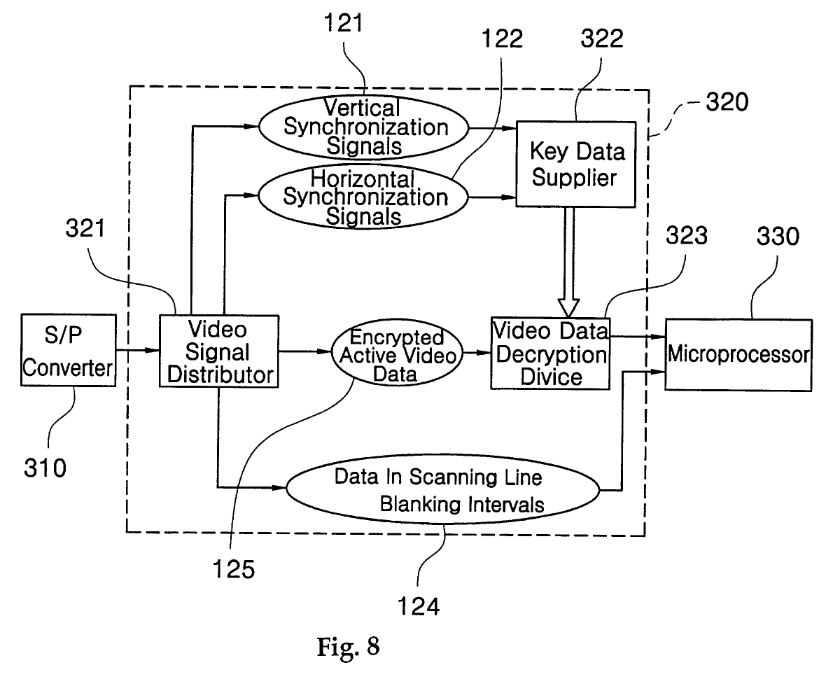

FIG. 8 is a block diagram showing the configuration of the decryption unit of the receiving unit of FIG. 2. The encrypted digital video signals, which are converted into the serial signals by means of the P/S converter 140, are inputted into the S/P converter 310 of the receiving unit 300 through the transmission means 200. The S/P converter 310 receives the encrypted serial digital video signals through the transmission means 200 and consecutively converts the serial signals into encrypted parallel digital video signals. The S/P converter 310 can be easily configured by changing the connection conditions of the D flip-flop circuits such that the serial data are inputted into an output stage of the P/S converter 140 and the parallel data are outputted from an input stage of the P/S converter.

The encrypted usable digital video signals, which have been converted into the parallel signals within the S/P converter 310, are inputted into the decryption unit 320. The decryption unit 320 according to the present embodiment comprises a video signal distributor 321, a key data supplier 322, and a video data decryption device 323. The video signal distributor receives the encrypted digital video signals from the S/P converter 310, and reads the horizontal synchronization signals 122, the vertical synchronization signals 121, the data 124 in the blanking intervals, the encrypted data 125 in the active line intervals from the received signals and outputs them respectively. The key data supplier 322 stores the plurality of encryption key data that are generated, based on the unique camera numbers 115 assigned to the cameras connected to the receiving unit 300, through the beforehand embedded encryption algorithm. That is, the key data supplier 322 stores the same encryption key data as the key data supplier 132 of the camera. The encryption key data are transmitted to the video data decryption device 323 so that they can be used for decrypting the encrypted active video data 125. If the vertical synchronization signals 121 are inputted from the video signal distributor 321, the key data supplier 322 selects the specific encryption key data among the plurality of stored encryption key data and transmits the selected encryption key data to the video data encryption device 323. Alternatively, if the horizontal synchronization signals 122 are inputted, the key data supplier 322 sequentially transmits the plurality of stored encryption key data to the video data decryption device 323. The video data decryption device 323 causes the encrypted data 125 in the active line intervals inputted from the video signal distributor 321 to be decrypted by using the encryption key data inputted from key data supplier 322 and then to be outputted to the microprocessor 330. In addition, the video signal distributor 321 causes the data 124 in the blanking intervals, which need not be decrypted, to be directly transmitted to the processor 330. In other words, after receiving the encrypted digital video signals, the video signal distributor 321 causes all the data 124 in the blanking intervals to be directly transmitted to the microprocessor 330 when the synchronization signals are detected, whereas it causes the encrypted data 125 in the active line intervals to be transmitted to and decrypted in the video data decryption device 323 when the synchronization signals are not detected. Consequently, the video data decryption device 323 transmits the decrypted data to the microprocessor 330. Thus, the microprocessor 330 receives the usable video signals completely decrypted from the distributed digital video signals and allows the usable video data to be mapped in response to the synchronization signals in the blanking intervals.

Since the video data decryption device 323 should perform the encryption logical operation in the reverse order in order to decrypt the data encrypted in the video data encryption device 133, it is configured to include a decryption operation unit capable of performing the encryption operation inversely and synchronously. Further, the video data decryption device includes a shift register for supplying the same key data to the decryption operation unit in synchronism with the encryption operation. The descriptions on the configurations of the decryption operation unit and the shift register are omitted herein because these configurations can be easily conceived from the configuration of the video data encryption device by those skilled in the art.

In order to correctly and synchronously decrypt the encrypted digital video signals transmitted through the transmission means, they should be decrypted by using the same key data values as those used upon encryption of the specific active video data. In the present invention, the synchronization between the encryption and decryption of the transmitted digital video signals is performed on the basis of the vertical synchronization signals of the digital video signals. That is, in a case where the vertical synchronization signals 121 are detected, the key data suppliers 132, 322 of the encryption and decryption units 130, 320 initialize the corresponding shift registers with the identical key data, respectively. Alternatively, in a case where the horizontal synchronization signals are detected, the same key data are provided to the video data encryption device 133 and the video data decryption device 323 in the same order as each other. Thus, completely synchronous encryption and decryption can be performed.

Furthermore, in a case where the time stamp data or voice data are inserted into the scanning line blanking intervals, the microprocessor 330 separates the time stamp data and the voice data from each other and confirms whether the time stamp data are consecutive. If not, the microprocessor can generate the warning signal. Further, the voice data can be converted into the voice signals, which are in turn outputted.

A second preferred embodiment of the present invention can be constructed in that the encryption and decryption are not incorporated in the system. A security system in accordance with this preferred embodiment does not have the encryption unit 130 in the camera 100 (FIG. 2), nor the decryption unit 320 in the receiving unit 300 (FIG. 2.) Instead, the DSP 120 is configured to insert security data in the digital video signals. Preferably, the security data are inserted into a blanking data region of the scanning line blanking interval. The security data preferably include time stamp data as discussed above in connection with the first preferred embodiment. Preferably, the security data further include security code for indicating specific cameras. For example, the camera number 115 can be used as the security code, with or without encryption in the DSP 120.

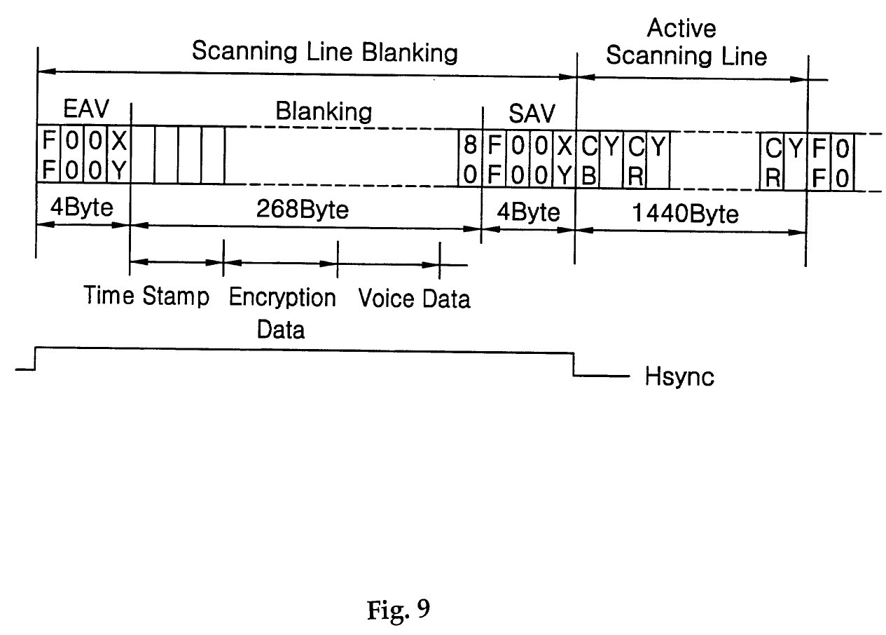

In this preferred embodiment, the DSP 120 receives from the CCD 110 and process raw video image signals to produce usable digital video signals. The resulting usable digital video signals preferably includes the security data in the blanking region as shown in FIG. 9, which is a equivalent to a single line display in a multiple line display frame. The usable digital video signal is processed at the P/S converter 140 to produce a serial data stream, which is transmitted to the receiving unit 300, as discussed above in connection with the first preferred embodiment of the present invention.

In the receiving unit 300, the serial data stream received is converted to parallel data stream at the S/P converter 310 preferably as they are received. The parallel data stream is transferred to the microprocessor 330, which extracts the synchronization signals, the time stamp data and encryption data from the scanning line blanking intervals of usable video signals for multiple lines. The microprocessor determines whether the extracted encryption data correspond to that of the one or more cameras connected to the receiving unit and whether the time stamp data from a series of usable digital video signal for the multiple lines have consecutive values. If the security data including the encryption data and time stamp data are correct, the usable video signals are outputted to the data compression unit 340 and/or external terminal 360. If the security data are determined incorrect or erroneous, the microprocessor 330 generates a warning signal. In other words, if values of the extracted time stamp data are not consecutive or the extracted encryption data are not identical to pre-stored encryption data (for example the camera number 115), the microprocessor 330 determines that the video signals have been altered or any other video signals have been inserted. The warning signal is outputted to the warning device 400 via the external terminal 360. Particularly, if the values of time stamp data are not consecutive, the video signals are considered as faked and inputted by an external intruder. If the encryption data from the usable video signal are not identical to the pre-stored encryption data, it can be considered that a camera itself is changed or the video signals are transmitted from a different camera. Moreover, the microprocessor 330 serves to control peripheral devices including the serial/parallel signal converter 310, the data compressor 340 and storage device 350.

According to the present invention, there is provided the method of encrypting the digital video signals in the security camera in real time. Since only data in the active scanning line intervals of the usable digital video signals outputted from the digital signal processor of the camera are encrypted, the amount of data to be encrypted is reduced so that a mass of video signals can be transmitted as digital signals, and security can be ensured even though the video signals are hacked during the transmission thereof.

Further, according to the present invention, there is provided the security camera with the encryption means for encrypting the digital video signals in the security camera in real time. Thus, the amount of data to be encrypted is reduced so that a mass of video signals can be transmitted as digital signals, and security can be ensured even though the video signals are hacked during the transmission thereof. Moreover, since the digital video signals can be transmitted, it is possible to provide image quality superior to that of a conventional camera for transmitting video signals as analog signals. Furthermore, the production costs of the camera can be reduced because the A/D and D/A converters are not required.

In addition, according to the present invention, there is provided the security system, wherein the digital video signals are encrypted and transmitted serially in real time and then decrypted in real time to be outputted to the monitor and to be compressed and stored, in order to prevent the external intruder from hacking the transmitted video signals and to avoid the loss and noise of the signals produced upon analog transmission of the video signals. Since the loss of the signals can be reduced, high quality images can be transmitted in real time. Further, since the time stamp data capable of checking the continuity of the transmitted video signals are transmitted together with the encrypted digital video signals, it is possible to recognize whether any other video signals are inputted from the outside or the camera is damaged. In addition, since the digital video signals can be transmitted serially via the coaxial cables used in the conventional security system, the installation costs thereof can be reduced.

The preferred embodiment described above and shown in the accompanying drawings should not be construed as limiting the technical spirit of the invention. The scope of the invention should be defined by the appended claims, and those skilled in the art can make various changes or modifications thereto without departing from the spirit and scope of the invention. Therefore, such changes or modifications will fall within the scope of the invention so far as they are obvious to those skilled in the art.

What is claimed is:

1. A method of improving security of video signal, comprising:
providing a usable video signal for use in a display with substantially little or no signal processing; and
processing the usable video signal to provide a secured video signal comprising at least one of an encrypted signal and a security signal.

2. The method of claim 1, wherein the provision of the usable video signal is carried out in a camera.

3. The method of claim 2, wherein the provision of the usable video signal comprises:
generating a raw video signal from light entering into the camera; and
converting the raw video signal to the usable video signal.

4. The method of claim 3, wherein the generation of the raw video signal is carried out with use of a charge coupled device (CCD).

5. The method of claim 3, wherein the raw video signal is in analog form, and wherein the conversion of the raw video signal comprises converting the analog raw video signal to digital form.

6. The method of claim 1, further comprising transmitting the secured video signal via a wired or wireless connection.

7. The method of claim 6, wherein the transmission is constantly carried out.

8. The method of claim 6, wherein the transmission is a serial transmission.

9. The method of claim 6, wherein the transmission is via a coaxial cable.

10. The method of claim 6, further comprising, before transmission, conducting a parallel-to-serial conversion of the secured video signal.

11. The method of claim 1, further comprising providing an audio signal and incorporating the audio signal into the usable video signal.

12. The method of claim 11, wherein the usable video signal comprises a plurality of line video signals, wherein each line video signal is capable of displaying a line of image on a display, wherein each line video signal comprises a vertical synchronization signal, a horizontal synchronization signal, a blanking signal and a line image signal, and wherein the audio signal is incorporated into the blanking signal.

13. The method of claim 1, wherein the usable video signal is in digital form, and wherein the processing is digital signal processing.

14. The method of claim 1, wherein the usable video signal is in either analog or digital form.

15. The method of claim 1, wherein the usable video signal is in a format selected from the group consisting of International Radio Consultative Committee (CCIR) and Society of Motion Picture and Television Engineers (SMPTE).

16. The method of claim 1, wherein the usable video signal comprises a plurality of line video signals, and wherein each line video signal comprises a vertical synchronization signal, a horizontal synchronization signal, a blanking signal and a line image signal.

17. The method of claim 1, wherein the security signal is one that can be used for detection of one or more selected from the group consisting of interception, alteration, hacking, duplication and replacement of a signal during transmission thereof.

18. The method of claim 17, wherein the security signal comprises a signal for a code identifying a source, from which the usable video data originates.

19. The method of claim 18, wherein the code comprises an identification code for a camera used to generate an original video signal.

20. The method of claim 17, wherein the security data comprises a signal indicative of a relative order of each video image segment.

21. The method of claim 1, wherein the processing comprising adding the security signal to the usable video signal to provide the secured video signal.

22. The method of claim 21, wherein the usable video signal comprises a video image segment and a control signal segment, and wherein the addition of a security signal comprises inserting the security signal into the control signal segment.

23. The method of claim 22, wherein the control signal segment comprises blanking signal and one or more synchronization signals, and wherein the addition of a security signal comprises inserting the security signal into the blanking signal.

24. The method of claim 21, wherein the usable video signal comprises a plurality of line video signals, wherein each line video signal is capable of displaying a line of image on a display, wherein each line video signal comprises a blanking signal and a line image signal, and wherein the addition of a security signal comprises inserting a signal indicative of the relative order of each line video signal into the blanking signal.

25. The method of claim 24, wherein the relative order signal comprises a signal indicative of a serial number for each line image signal.

26. The method of claim 1, wherein the encrypted signal is one that has to be subject to decryption processing for intended use thereof.

27. The method of claim 1, wherein the processing comprises encrypting at least part of the usable video signal.

28. The method of claim 27, wherein the usable video signal comprises a video image segment and a control signal segment, and wherein the encryption comprises encoding at least part of the video image segment.

29. The method of claim 28, wherein the encrypting comprises separating the at least part of the usable video signal for encryption and then encoding the separated part of the usable video signal.

30. The method of claim 29, wherein the encrypting further comprises combining the encrypted signal with non-encrypted signal.

31. The method of claim 28, wherein the control signal segment comprises one or more synchronization signals, and wherein the encryption is initiated by recognition of the one or more synchronization signals.

32. The method of claim 27, wherein the usable video signal comprises a plurality of line video signals, wherein each line video signal is capable of displaying a line of image on a display, wherein each line video signal comprises a vertical synchronization signal, a horizontal synchronization signal, a blanking signal and a line image signal, and wherein the encrypting comprises:
separating the line image signal and the remainders from each line video signal;
encoding the line image signal to provide an encoded line image signal; and
combining the encoded line image signal and the remainders to provide the secured video signal.

33. The method of claim 32, wherein the encrypting further comprises:
recognizing the vertical and horizontal synchronization signals; and
synchronizing the encoding of the line image with the recognition of the vertical and horizontal synchronization signals.

34. A method of improving security of video signal for transmission, comprising:
obtaining a raw video signal requiring a substantial signal processing for use in a display;
processing the raw video signal to provide a usable video signal comprising a video image signal and a control signal; and
encrypting at least part of the video image signal to provide a secured video signal.

35. The method of claim 34, wherein the encryption comprises:
separating the video image segment from the control signal segment; and
encoding the video image segment based on one or more control signals contained in the control signal segment.

36. The method of claim 34, wherein the provision of the secured video signal further comprises combining the control signal segment and the encrypted video image segment.

37. The method of claim 34, further comprising adding a security signal to the usable video signal.

38. The method of claim 37, wherein the security signal is inserted into the control signal segment of the usable video signal.

39. The method of claim 34, wherein the control signal segment is not subject to the encoding.

40. The method of claim 34, wherein the encryption comprises supplying a plurality of security codes in a predetermined order and encoding the video image segment with use of the plurality of security codes.

41. The method of claim 40, wherein the supply of a plurality of security codes comprises repeatedly providing a limited number of security codes in an order for the encoding.

42. The method of claim 40, wherein the control signal segment comprises vertical and horizontal synchronization signals, and wherein the provision of secured video signal comprises supplying a first security code for the encoding upon recognition of the vertical synchronization signal, and initiating continuous supply of the plurality of security codes for the encoding upon recognition of the horizontal synchronization signal.

43. A method of producing a usable video signal from a secured video signal, comprising:
providing a secured video signal comprising either or both of a security signal and an encrypted signal; and
processing the secured video signal to produce a usable video signal that is ready for use in a display with substantially little or no signal processing.

44. The method of claim 43, wherein the provision of the secured video signal comprises receiving the secured video signal transmitted via a wired or wireless connection.

45. The method of claim 44, wherein the receipt of the secured video signal is via a serial connection, and wherein the provision of the secured video signal comprises conducting a serial-to-parallel conversion of the serially received secured video signal.

46. The method of claim 43, wherein the provision of the secured video signal comprises retrieving the secured video signal from a storage device storing thereof.

47. The method of claim 43, further comprising displaying a video image of the usable video signal with use of a display.

48. The method of claim 43, further comprising storing the usable video signal in a memory or storage device.

49. The method of claim 48, further comprising archiving the usable video signal before storing.

50. The method of claim 43, wherein the processing comprising decrypting the encrypted signal.

51. The method of claim 43, wherein the secured video signal comprises a plurality of secured line video signals, wherein each secured line video signal comprises either or both of the security signal and the encrypted signal, wherein the processing comprises separating the encrypted signal from each secured line video signal, and wherein the processing further comprises decrypting the encrypted signal.

52. The method of claim 43, wherein the processing comprising checking whether the secured video signal provided has been subject to one or more selected from the group consisting of interception, alteration, hacking, duplication and replacement.

53. A method of operating a video surveillance system, the method comprising:
receiving a video signal transmitted from a source;
identifying one or more irregularities in the transmission of the received signal, wherein the one or more irregularities are selected from the group consisting of interception, alteration, hacking, duplication and replacement of at least part of the secured video signal; and
processing the received video signal to produce a usable video signal, which is ready for use in a digital display with substantially little or no data processing.

54. The method of claim 53, further comprising storing the received video signal before or after the received signal is processed by the processor.

55. The method of claim 53, further comprising conducting a serial-to-parallel conversion of the received video signal.

56. The method of claim 53, wherein the received video signal is supposed to include an encrypted signal, wherein the identification comprises determining whether the received video signal includes the encrypted signal.

57. The method of claim 53, wherein the received video signal comprises an encrypted signal, wherein the identification comprises determining whether the processor can decrypt the encrypted signal.

58. The method of claim 53, wherein the received video signal comprises an encrypted signal, wherein the processing comprises decrypting the encrypted signal to produce the usable video signal.

59. The method of claim 58, wherein the received video signal comprises an image segment and a non-image segment, and wherein the encrypted signal corresponds to the image segment.

60. The method of claim 58, wherein the received video signal further comprises a non-encrypted signal, the decrypting comprises separating the encrypted signal from the non-encrypted signal, decoding the separated encrypted signal to produce a decrypted signal, and combining the decrypted signal and the non-encrypted signal.

61. The method of claim 58, wherein the decrypting comprises generating at least one security key for use in the decoding.

62. The method of claim 58, wherein the received video signal further comprises a non-encrypted signal, wherein the processing comprises synchronizing the decryption with a synchronization signal contained in the non-encrypted signal of the received video signal.

63. The method of claim 58, wherein the usable video signal produced by the decryption comprises a security signal.

64. The method of claim 58, wherein the received video signal comprises an encrypted signal representing an image data for a single line of a multiple-line frame, a vertical synchronization signal, a blanking signal and a horizontal synchronization signal; wherein the received signal further comprises at least one security signal incorporated in the blanking signal; wherein the decryption decrypts the encrypted signal to produce the usable video signal; and wherein the processing further comprises separating the security code from the blanking signal for further processing.

65. The method of claim 53, wherein the received video signal is supposed to include a security signal, wherein the identification comprises determining whether the received signal includes the security signal.

66. The method of claim 53, wherein the received video signal comprises a security signal comprising one or more sub-signals for use in confirming perfection of transmission of the security signal and, wherein the identification comprises separating the security signal for further processing.

67. The method of claim 66, wherein the security signal comprises a sub-signal representing an identification code for the source.

68. The method of claim 67, wherein the identification further comprises determining whether the identification code from the security signal matches with pre-stored information of the same source.

69. The method of claim 66, wherein the received video signal comprises signals representing a plurality of image segments, and wherein the security signal comprises a sub-signal indicative of a relative order of each image segment.

70. The method of claim 69, wherein the identification comprises determining whether the sub-signal indicative of a relative order matches with a relative order of receipt of the plurality of image segments in the received video signal.

71. A video data stream being transmitted via a wireless or wired connection in a video surveillance system, the data stream comprising a plurality of line video signals, each line video signal comprising a vertical synchronization signal, a blanking signal, a horizontal synchronization signal and a line image signal, wherein at least part of the line image signal is in an encrypted form.

72. The video data stream of claim 71, further comprising audio data, wherein the audio data are inserted in the blanking signal.

73. The video data stream of claim 71, further comprising source identification data for identifying a source of the video data stream.

74. The video data stream of claim 72, wherein the source identification data are inserted in the blanking signal.

75. The video data stream of claim 71, further comprising sequence data for indicating relative order of each line video signal.

76. The video data stream of claim 75, wherein the sequence data are inserted in the blanking signal.

77. The video data stream of claim 71, wherein the video data stream is transmitted serially.

78. A method of generating the video data stream of claim 71, the method comprising:
providing a usable video signal for use in a display with substantially little or no signal processing;
encrypting the at least part of the line image signal of the usable video signal;
combining the encrypted part of the line image signal and the remainder of the usable video signal; and
transmitting the combined signals.
